(19) United States
(12) Patent Application Publication
(10) Pub. No.: US 2005/0243819 A1
(43) Pub. Date: Nov. 3, 2005

(54) Internet phone system and method for peer to peer communication

(76) Inventors: Chin-Lung Peng, Taipei (TW); Li-Hsing Huang, Hsin-chu (TW); Cheng-Hsien Ku, Yung-Ho (TW)

Correspondence Address: G. LINK CO., LTD.;Suite 137, PmB 174, 931 West 75th Street, Naperville, IL, 60565, US

(21) Appl. No.: 10/936,578

(22) Filed: Sep. 9, 2004

(30) Foreign Application Priority Data
Apr. 30, 2004 (TW) 093112297

(51) Int. Cl. H04L 12/66

(52) U.S. Cl. 370/389

(57) ABSTRACT

An internet phone system and a peer to peer communication method are described. The internet phone system includes a first area DNS, a first area server, a second area server and an upper layer server. When a user calls the individual number of a second internet phone, the first area server looks up the IP address of the second internet phone, through the DNS system, according to the individual number and of the second internet phone and establishes a peer to peer communication between the first internet phone and the second internet phone. When a user calls the internet phone number of the third internet phone, the second area server looks up the IP address of the third internet phone, through the DNS system, according to the individual number of the third internet phone, and establishes a peer to peer communication between the first internet phone and the third internet phone.

### BACKGROUND OF THE INVENTION

1. Field of Invention

The present invention relates to an internet phone system. More particularly, the present invention relates to an internet phone system providing the service of automatically matching the internet phone number and the corresponding IP address.

2. Description of Related Art

Traditionally, in an internet pone system, a private protocol is defined and private servers are used to establish a peer to peer communication and to send information packages. The receiver internet phone receives the information packages, decompresses, and decodes the information packages to a voice signal using a specific decoding technique. Thus, a peer to peer internet phone communication procedure is finished.

Recently, ITUI and IETF have provided various communication standards regarding the VOIP protocol, the communication standards such as H.323, MGCP, MegaCo, or SIP. Different package header types are defined according to different communication protocols.

According to the RFC, MGCP and MegaCall need instructions provided by call-agent servers to finish a peer to peer communication. If the server system fails, all internet phones in the group can not use the peer to peer communication service.

An H.323 embedded internet phone needs a Soft Switch or a GateKeeper service in charge of the peer to peer communication service for registered internet phones. It supports intelligent terminal algorithm and therefore a peer to peer communication is possible. However, the way of establishing a phone call needs to call “IP plus Port number”, “IP plus Domain Name”, or “private internet phone number plus domain name” compatible with the protocol stack header type. The caller and the receiver define their own private internet phone numbers. The formats and the lengths of the private internet phone numbers are limited.

A SIP embedded internet phone needs a Soft Switch or a Proxy server in charge of the peer to peer communications for the registered internet phones in their domain. It also supports intelligent terminal algorithm and therefore a peer to peer communication can be established without a Soft Switch when the internet phones do not register in a Proxy server in the domain. However, the way of establishing a phone call needs to call “IP plus Port number”, “IP plus Domain Name”, or “private internet phone number plus domain name”. All the formats must conform to the SIP protocol stack header. The caller and the receiver define their own private internet phone numbers. The formats and the lengths of the private internet phone numbers are limited.

As mentioned above, without a Soft Switch, a Proxy server, and a GateKeeper to provide the internet phones with a client to server register service, an internet phone user is easy to make mistakes when calling the internet phone number and an IP address. When the Soft Switch or the Proxy server fails and when a SIP embedded or an H.323 embedded internet phone is establishing a peer to peer communication, an internet phone user is easy to make mistakes when calling the internet phone number and an IP address, too. The method dose not conform to the usual habit of making a common phone call.

For the forgoing reasons, there is a need for designing an internet phone system having the following advantages. The internet phone system must have no territory boundary limits. The internet phone system must provide a service for any peer to peer communication that is as convenient as making an usual phone call. The internet phone system must provide an automatic registering and an automatic internet phone number designation mechanism. The internet phone system must provide a service to display multimedia signals and conform to human nature.

### SUMMARY OF THE INVENTION

It is therefore an objective of the present invention to provide an internet phone system. The internet phone system utilizes the DNS system well established around the world to distribute the load of the peer to peer communication to a DNS to increase the efficiency.

It is another objective of the present invention to provide an internet phone system. In the internet phone system, when establishing a peer to peer communication, an internet phone only has to call the internet phone number of the target internet phone number without calling the IP addresses of the caller or the receiver. The internet phone system can obtain the IP address of each internet phone from the DNS system and establish a peer to peer communication.

It is still another objective of the present invention to provide an internet phone system. In the internet phone system, each internet phone can register automatically and get a unique internet phone number. It conforms to the usual habit of ordinary phone users.

It is still another objective of the present invention to provide an internet phone system. The internet phone system support all types of IP, such an a dynamic IP or a static IP.

It is still another objective of the present invention to provide an internet phone system. In the internet phone system, a peer to peer communication is established with out a Soft Switch, a Proxy, or a GateKeeper.

It is still another objective of the present invention to provide an internet phone system. The internet system provides the function of editing graphic greeting words in the form of multi media. The graphic greeting words replace the traditional method of displaying the phone number of the caller on the display module of an internet phone.

It is still another objective of the present invention to provide an internet phone system. A web site can be established in the internet phone system for users to search the authorized information of registered internet phones.

It is still another objective of the present invention to provide an internet phone system. The internet phone system broadcasts a broadcasting signal to check the on line statuses of other internet phones.

In accordance with the foregoing and other objectives of the present invention, an internet phone system is provided. According to a preferred embodiment of the invention, the internet phone system is used for peer to peer communications among a plurality of internet phones. Each internet phone has an internet phone number. Each internet phone number includes an area number and an individual number.

The internet phone system includes a first area server, a first area DNS, a second area server, a second area DNS, an upper layer server, and an upper layer DNS. The first area server is connected to at least one first internet phone and at least one second internet phone. The first area server has a first area data base for a searching service. The first area data base records the internet phone number of the first internet phone and the second internet phone and the corresponding IP addresses of the first internet phone and the second internet phone. The internet phone numbers and the corresponding IP address are also stored in the first area DNS. When the first internet phone calls the individual number of the second internet phone, the first internet phone looks up the individual number and the corresponding IP address of the second internet phone through a DNS system provided by an ISP. When the corresponding IP address of the second internet phone can not be found in a DNS provided by the ISP, the corresponding IP address of the second internet phone is searched in an upper layer DNS. The corresponding IP address of the second internet phone is searched upward layer by layer through the DNS system. At last, The corresponding IP address of the second internet phone can be found in the first area DNS, in which the individual number and the corresponding IP address of the second internet phone are stored.

The second area server is connected to a third internet phone. The second area server has a second area data base. The second area data base records the individual number and the corresponding IP address of the third internet phone. The individual number and the corresponding IP address of the third internet phone are also stored in the second area DNS.

The upper layer server is connected to the first area server and the second area server. When the first internet phone calls the individual number of the third internet phone, the first internet phone looks up the corresponding IP address of the third internet phone through a DNS system provided by an ISP. When the corresponding IP address of the third internet phone can not be found in a DNS provided by the ISP, the corresponding IP address of the third internet phone is searched in an upper layer DNS. The corresponding IP address of the third internet phone is searched upward layer by layer through the DNS system. At last, The corresponding IP address of the third internet phone can be found in the second area DNS, in which the internet phone number and the corresponding IP address of the third internet phone are stored. Thus, a peer to peer communication is established.

The internet phone system can further include a plurality of extra area servers and a plurality of extra internet phones. The upper layer server, the extra area servers and the extra internet phones form a tree structure.

Each of the first internet phone, the second internet phone, and the third internet phone can have a display module. When a peer to peer communication is established, the display module displays the information sent from the caller. The information sent from the caller is, for example, a graphic greeting word.

The first area server can periodically broadcast a broadcasting signal. The broadcasting signal is displayed on the display modules of the first internet phone and the second internet phone. The first area server checks the on line statuses of the first internet phone and the second internet phone through the broadcasting signal. The first area server can provide relating information of internet phone users according to the limits of authority.

In accordance with the foregoing and other objectives of the present invention, an internet phone system and a peer to peer communication method are provided. According to a preferred embodiment of the invention, the internet phone system is used for peer to peer communications among a plurality of internet phones. Each internet phone has an individual number. The internet phone system includes a first area DNS, a second area DNS, an upper layer server, and an upper layer DNS.

The first area server has a first area data base. The first area data base records the internet phone number and the corresponding IP address of each internet phone. The first area server receives the IP address sent from a first internet phone and a second internet phone. The IP addresses of the first internet phone and the second internet phone are recorded in the first area data base. The individual number of the internet phones and the corresponding IP addresses are also changed in the first area DNS. When the first internet phone calls the individual number of the second internet phone, the first internet phone looks up the IP address of the second internet phone through a DNS system provided by an ISP to establish a peer to peer communication. When the first internet phone calls the individual number of a third internet phone, the first internet phone looks up the IP address of the third internet phone through a DNS system provided by an ISP to establish a peer to peer communication.

The invention has at least the following advantages. Because the internet phone system can be divided into a first area and a second area, the internet phone system distributes the load of the peer to peer communication to different servers (the first area server, the first area DNS, the second area server, and the second area DNS) to increase the efficiency. The DNS system is in charge of the peer to peer communication procedure and the load of the whole system is released.

Moreover, in the internet phone system, because the IP address of each internet phone can be searched automatically through the DNS system, an internet phone only has to call the internet phone number of the target internet phone without calling the IP addresses of the caller or the receiver.

In the internet phone system, each internet phone can register automatically and get a unique internet phone number. It conforms to the usual habit of ordinary phone users. The internet phone system support all types of IP, such an a dynamic IP or a static IP.

In the internet phone system, a peer to peer communication is established without a Soft Switch, a Proxy, or a GateKeeper. The internet system provides the function of editing graphic greeting words in the form of multimedia. The graphic greeting words replace the traditional method of displaying the phone number of the caller on the display module of an internet phone.

A web site can be established in the internet phone system for users to search the authorized information of registered internet phones. The internet phone system broadcasts a broadcasting signal to check the on line statuses of other internet phones.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a diagram illustrating a preferred embodiment of the invention;

FIG. 2 is a diagram illustrating another preferred embodiment of the invention;

FIG. 3 is a diagram illustrating another preferred embodiment of the invention; and

FIG. 4 is a diagram illustrating a flow chart of a preferred embodiment of the method for establishing a peer to peer communication.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description to refer to the same or like parts.

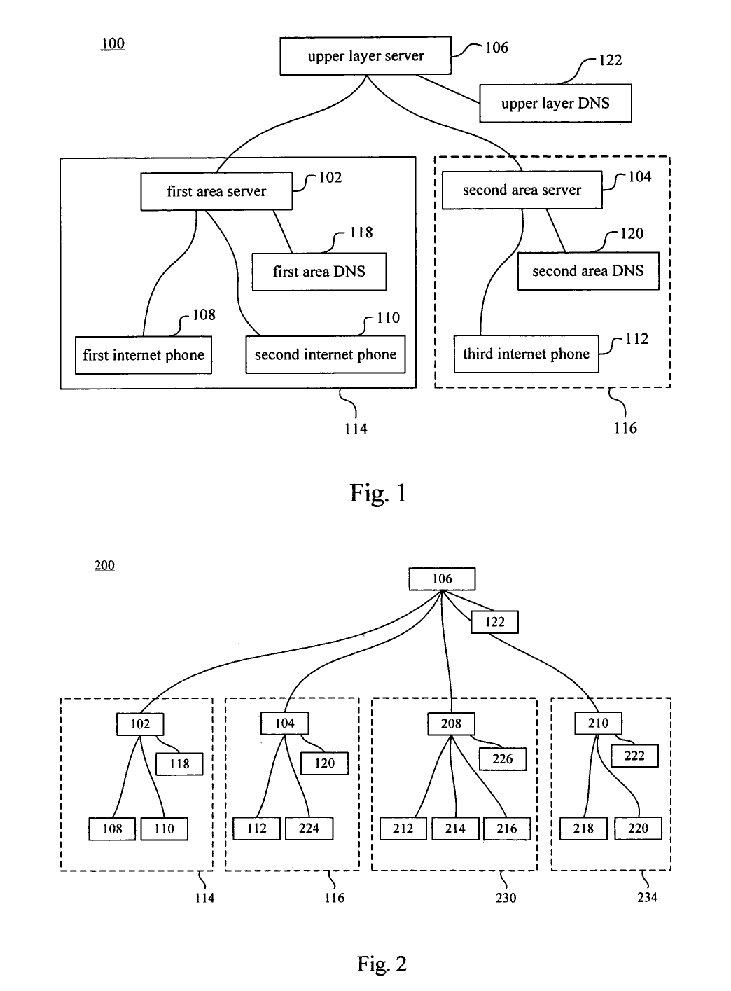

FIG. 1 is a diagram illustrating a preferred embodiment of the invention. With reference to FIG. 1, internet phone system 100 is used to establish peer to peer communications among a plurality of internet phones. Each internet phone has an internet phone number. Each internet phone number includes an area number and an individual number. The internet phone system 100 includes at first area server 102, a second area server 104, and an upper layer server 106. The first area server 102 is connected to a first internet phone 108 and a second internet phone 110. The first area server 102 has a first area data base. The first area data base records the individual number of the first internet phone 108 and the second internet phone 110 and the corresponding IP addresses of the first internet phone 108 and the second internet phone 110. The individual number and the corresponding IP addresses of the first internet phone 108 and the second internet phone 110 are written into the first area DNS (domain name server) 118. When the first internet phone 108 calls the individual number of the second internet phone 110, the first internet phone 108 looks up the individual number and the corresponding IP address of the second internet phone 110 through a DNS system provided by an ISP (internet service provider). When the corresponding IP address of the second internet phone 110 can not be found in a DNS provided by the ISP, the corresponding IP address of the second internet phone 110 is searched in an upper layer DNS. The corresponding IP address of the second internet phone 110 is searched upward layer by layer through the DNS system. At last, The corresponding IP address of the second internet phone 110 can be found in the first area DNS 118, in which the individual number and the corresponding IP address of the second internet phone 110 are stored. A peer to peer communication between the first internet phone 108 and the second internet phone 100 is then established.

The second area server 104 is connected to a third internet phone 112. The second area server 104 has a second area data base. The second area data base records the individual number of the third internet phone 112 and the corresponding IP address of the third internet phone 112. The internet phone number and the corresponding IP address of the third internet phone 112 are written into the second area DNS 120. The upper layer server 106 is connected to the first area server 102 and the second area server 104. When the first internet phone 108 calls the internet phone number of the third internet phone 112, the upper layer server 106 looks up the corresponding IP address of the third internet phone 112 through a DNS system provided by an ISP. When the corresponding IP address of the third internet phone 112 can not be found in a DNS provided by the ISP, the corresponding IP address of the third internet phone 112 is searched in an upper layer DNS. The corresponding IP address of the third internet phone 112 is searched upward layer by layer through the DNS system. At last, The corresponding IP address of the third internet phone 112 can be found in the second area DNS 120, in which the individual number and the corresponding IP address of the third internet phone 112 are stored. A peer to peer communication between the first internet phone 108 and the third internet phone 112 is then established.

In FIG. 1, the first area server 102, the first internet phone 108, and the second internet phone 110 constitutes a first area 114. The second area server 104 and the third internet phone 112 constitutes a second area 116. When establishing a peer to peer communication, no matter whether the path of the peer to peer communication is across different areas, the corresponding IP addresses do not need to be searched in an upper sever or area servers. The DNS system is responsible for the searching actions.

In the first area 114, when establishing a peer to peer communication, such as the peer to peer communication between the first internet phone 108 and the second internet phone 110, the first internet phone 108 doesn't have to call the area number of the second internet phone 110. Instead, the first internet phone 108 only has to call the individual number of the second internet phone 110. The first internet phone 108 uses a predetermined area number for the second internet phone 110. If the area number of the second internet phone 110 is not sent, it means the peer to peer communication is within the same area. The first internet phone 108 automatically added the predetermined area number to the individual number of the second internet phone 110. The predetermined area number and the individual number of the second internet phone 110 constitute a complete internet phone number. The complete internet phone number is provided to the DNS system. The IP address of the first internet phone 108 can be a dynamic IP address. The IP address of the second internet phone 110 also can be a dynamic IP address.

When establishing a peer to peer communication across different areas, such as the peer to peer communication between the first internet phone 108 and the third internet phone 112, the first internet phone 108 has to call the complete internet phone number, including the area number and the individual number, of the third internet phone 112. The complete internet phone number is provided to the DNS system to establish a peer to peer communication. Therefore, the burden of the management of peer to peer communications is distributed to the DNS system. The whole system reduces its burden of the busy communication traffic.

The first area server 102 has a first area data base. The first area data base records the individual numbers and the corresponding IP addresses of all the internet phones in the first area 114. When the first internet phone 108 changes its own IP address, the first internet phone 108 sends the new IP address to the first area server 102. The first area server 102 updates the internet phone number and the corresponding IP address. The first area DNS 118 also updates the internet phone number and the corresponding IP address of the first internet phone 108. The second area server 104 has a second area data base. The second area data base records the internet phone numbers and the corresponding IP address of all the internet phones in the second area 116. When the third internet phone 112 changes its own IP address, the third internet phone 112 sends the new IP address to the second area server 104. The second area server 104 updates the internet phone number and the corresponding IP address. The second area DNS 120 also updates the internet phone number and the corresponding IP address of the third internet phone 112. The first internet phone 108, the second internet phone 110, and the third internet phone 112 are just examples. A designer is allowed to increase the number of internet phones in the first area 114 or in the second area 116. Additional areas can also be added to the internet phone system according to the same architecture.

FIG. 2 is a diagram illustrating another preferred embodiment of the invention. With reference to FIG. 2, the system in FIG. 2 is derived the system in FIG. 1. Compared with the system in FIG. 1, more devices are shown in the system in FIG. 2. The internet phone system 200 includes a first area 114, a second area 116, a third area 230, and a forth area 234. Each area has a plurality of internet phones. Excluding the devices shown in FIG. 1, the internet phone system 200 includes a plurality of extra area servers (208 and 210) and a plurality of extra internet phones (212,214,216,218, and 220).

The upper layer server 106 is connected to the extra area servers (208 and 210). The extra area servers (208 and 210) are connected to the extra internet phones (212,214,216,218, and 220). The upper layer server 106, the area servers (208 and 210) and the extra internet phones (212,214,216,218, and 220) form a tree structure.

In FIG. 2, Each internet phone has an internet phone number. Each internet phone number has an area number. For example, when the first internet phone 108 is establishing a peer to peer communication with the internet phone 220, the IP address of the internet phone 220 is searched in DNS 222 and sent back. The relationship between the IP address and the internet phone number of the first internet phone 108 is recorded both in the first area server 102 and in the first area DNS 118. The relationship between the IP address and the internet phone number of the internet phone 220 is recorded both in the area server 210 and in the area DNS 222.

For another example, when the first internet phone 108 is establishing a peer to peer communication with the internet phone 224, the IP address of the internet phone 224 is first searched in the DNS system, and finally searched in the DNS 120 and sent back. The relationship between the IP address and the internet phone number of the first internet phone 108 is recorded both in the first area server 102 and in the first area DNS 118. The relationship between the IP address and the internet phone number of the internet phone 224 is recorded both in the second area server 104 and in the second area DNS 120.

For example, an area number includes a country number and a local number. The country number is, for example, represented by 000˜999. The local number is, for example, represented by 00˜99. An individual number is, for example, represented by 00000000˜99999999. Therefore, over 9800 Giga internet phone numbers can be used. The internet phone system 200 can reserve a plurality of unused country numbers as predetermined country numbers. An internet country can have approximately 100 local areas and each local area can have 1018 internet phone numbers. The internet phone numbers are enough for people around the world.

The predetermined internet phone number is, for example, 000-00-00000000. For example, with reference to FIG. 2, when the first internet phone 108 automatically registers in the first area server 102, the first area server 102 generates an unused 10 numerals (without a country number) as the unique internet phone number and the internet phone number is sent back to the first internet phone 108. The internet phone number and the IP address of the first internet phone 108 are recorded in the first area data base and in the first area DNS 118.

A user can select an internet phone number from the unused internet phone numbers listed on the web site for personal use. After changing the internet phone number, when the first internet phone 108 connects to the internet again, the first area server 102 sends the new internet phone number to the first internet phone 108. The first area server 102 also updates the internet phone number and the corresponding IP address of the first internet phone 108 in the first area DNS 118. The area servers (102, 104, 208, and 210) are, for example, responsible for the registration of each internet phone in corresponding areas.

In FIG. 2, each of the internet phones, for example, has a display module. When a peer to peer communication is established, the display module displays the information sent from the caller. The information sent from the caller is, for example, a graphic greeting word. The display module is, for example, a liquid crystal display module.

A graphic greeting word can be sent from a caller or a receiver. Before a caller makes a phone call, the caller can search the on line statuses of other users on the web site or through the internet phone. The on line status is, for example, on-line, off-line, or in a meeting status. When a caller makes a phone call, the display module of the receiver internet phone displays the graphic greeting word. A greeting word expressed in a graphic form is a solution to the language obstacles in different countries and is livelier.

In one embodiment, the web site mentioned above is placed in an area server, such as 102, 104, 208, or 210. In another embodiment, the web site is placed in the upper layer server 106, too. In one embodiment, the action of registering and sending the broadcasting signal can be done through an area server, such as 102, 104, 208 or 210. In another embodiment, the action of registering and sending the broadcasting signal is done through the upper layer server 106.

Take FIG. 2 as an example, the first internet phone 108 and the second internet phone 110 can edit their own graphic greeting words in the first area server 102 or upload the greeting words to the first area server 102. The greeting words in the first area server 102 can be updated in the first data base.

The first area server 102 accepts an inquiry from an internet phone to check whether the greeting words of the caller or the receiver has been changed. If the greeting word has been changed, a renewing code is sent back to the internet phone. The internet phone receives the renewing code and checks the first data base to get the new greeting word from the caller or the receiver.

The first area server 102 provides a web site for searching service. When an internet phone registers in the first area server 102, the internet phone is allowed to select the information it wants to open to public. The information is accessible to anyone by entering a key word in the searching service in the web site. The first area server 102 provides relating information of internet phone users according to the limits of authority. For example, only the authorized information is allowed to be opened to public, other information is not. The information is, for example, the country number, the area number, or the name of an internet phone. The searching results reveal the authorized information and the on line statuses of other internet phone users. Graphic greeting words, for example, can be used to represent the on line statuses.

The web site mentioned above can be located in an area server, such as 104, 208, or 210. The web site also can be located in the upper layer server 106.

The first area server 102 provides a broadcasting signal and the broadcasting signal is displayed on the display module of the first internet phone 108 or the second internet phone 110. The first area server 102, for example, periodically broadcasts the broadcasting signal, the broadcasting signal is displayed on the display modules of the first internet phone 108 and the second internet phone 110. The first area server 102 checks the on line statuses of the first internet phone 108 and the second internet phone 110 through the broadcasting signal.

For example, with reference to FIG. 2, in the internet phone system 200, the first area server 102 provides news or advertisement broadcasting service or provides personal channels for receiving the messages from friends. The first area server 102 can provide a friend-making channel for message transmission management for all users around the world.

For example, after an internet phone user registers in the first area server 102, the user can designate specific channels and a good-friend list. Only users listed in the good-friend list are allowed to send private messages to the user.

The first area server 102 can periodically receives the check of an internet phone. Information in personal channels and designated classified channels is transmitted to the internet phone once at a time and displayed on a marquee shown on the display module of the internet phone.

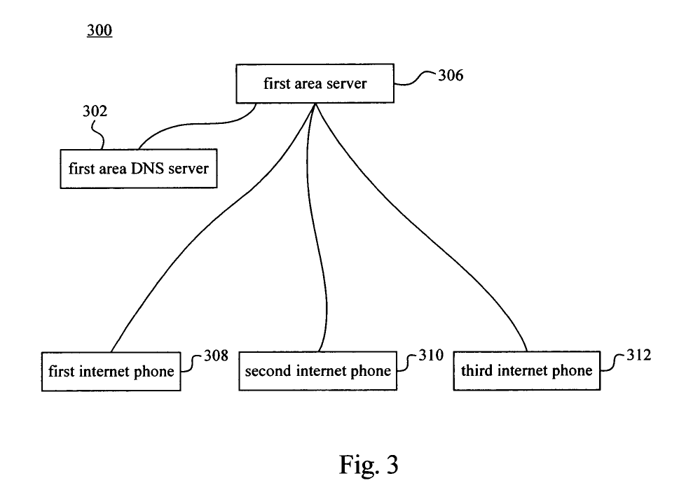

FIG. 3 is a diagram illustrating another preferred embodiment of the invention. With reference to FIG. 3, the internet phone system 300 includes a first area DNS 302 and a first area server 306. The first area server 306 is connected to a first internet phone 308, a second internet phone 310, and a third internet phone 312. The first area server 306 is connected to the first area DNS 302.

The first area server 306 has a first area data base. The first area data base records the internet phone numbers and the corresponding IP addresses of the internet phones (308, 310, and 312) for a searching service. If an internet phone first registers, or changes its internet phone number, in the first area server 306, the first DNS 302 updates the internet phone number and the corresponding IP address of the internet phone synchronously.

When the first internet phone 308 calls the individual number of the second internet phone 310 or the third internet phone 312, the first internet phone 308 looks up the IP address of the target internet phone, through a DNS system provided by an ISP. If the first internet phone 308 can not find the IP address of the target internet phone, the first internet phone 308 searches upward layer by layer in the DNS system provided by the ISP. At last, the IP address of the target internet phone can be found in the first area DNS 302 and a peer to peer communication between the first internet phone 308 and the target internet phone is established.

The embodiment shown in FIG. 3 can be combined with the embodiment shown in FIG. 1. The embodiment shown in FIG. 2 is an example of the combination of FIG. 1 and FIG. 3. One skilled in the art is able to establish a modified system with reference to FIG. 1, FIG. 2, and FIG. 3. The modification cannot be viewed as being out of the scope of the invention.

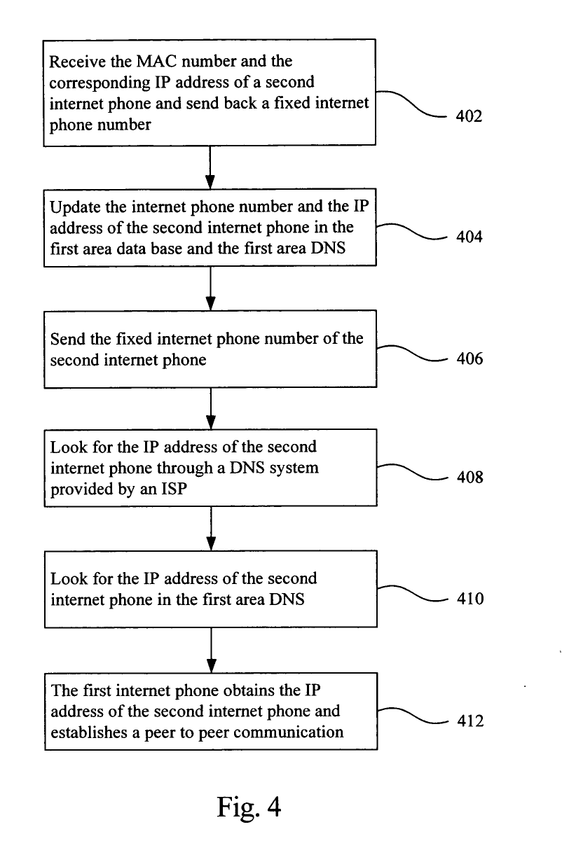

FIG. 4 is a diagram illustrating a flow chart of a preferred embodiment of the method for establishing a peer to peer communication. The flow chart is suitable for all the embodiments shown in FIG. 1, FIG. 2, and FIG. 3. For example, with reference to FIG. 4 and FIG. 3, the method includes the following steps. First, the first area server 306 receives the MAC number and the IP address of the internet phone 312 and sends back its fixed internet phone number to the internet phone 312 (step 402). Next, the data base of the first area server 306 and the internet phone number and the IP address stored in the first area DNS 302 are updated (step 404). Next, the first internet phone 308 calls the fixed internet phone number of the third internet phone 312 (step 406).

Next, the first internet phone 308 looks up the IP address of the third internet phone 312 through a DNS system provided by an ISP (step 408). Finally, the DNS 302 is searched according to the domain name behind the internet phone number. The first area DNS 302 informs the first internet phone 308 with the IP address of the third internet phone 312 (step 410). Next, the first internet phone 308 obtains the IP address of the third internet phone 312 and a peer to peer communication is established (step 412).

Before the third internet phone 312 obtains a fixed internet phone number, the following steps can be used to register in the server 306. First, the MAC number and the IP address of the internet phone 312, and a predetermined internet phone number are sent to the server 306. Next, the server 306 determines the fixed internet phone number of the internet phone 312 according to the MAC number of the internet phone 312 and the predetermined internet phone number. Next, the server 306 sends the fixed internet phone number of the internet phone 312 to the internet phone 312. The server 306 also sends the internet phone number and the corresponding IP address of the third internet phone 312 to the first area DNS 302 and stores them in the first area DNS 302. The third internet phone 312 then finishes the procedure of registering.

The third internet phone 312 also can select its preferred fixed internet phone number. First, the third internet phone 312 selects its preferred fixed internet phone number on a web site in the first area server 306. Next, when the third internet phone 312 connects to the first area server 306, the first area server 306 sends the new fixed internet phone number to the third internet phone 312 and updates the relationship between the internet phone number and the IP address. Thus, the procedure of changing the internet phone number is finished.

The server 306 also can check the on line status of each internet phone according to the following steps. First, the server 306 broadcasts a broadcasting signal periodically, so that the broadcasting signal is displayed on the display modules of the internet phones 308, 310, and 312. Next, the server 306 checks the on line statuses of the internet phones 308, 310, and 312 and the second internet phone through the broadcasting signal.

The invention has at least the following advantages. For example, in FIG. 1, because the internet phone system 100 has the first area server 102, the first area DNS 118, the second area server 104, and the second area DNS 120, the internet phone system 100 distributes the load of the peer to peer communication to different servers (the first area server 102, the first area DNS 118, the second area server 104, and the second area DNS 120) to increase the efficiency. The DNS system is in charge of all the peer to peer communication procedures. The area servers are only in charge of the registering of internet phones and the updating of the internet phone numbers and the corresponding IP addresses. Therefore, the load of the whole system is distributed.

Moreover, in the internet phone system 100, because the IP address of each internet phone can be searched automatically through the DNS system (like 118 or 120), an internet phone only has to call the internet phone number of the target internet phone without calling the IP addresses of the caller or the receiver.

In the internet phone system 100, each internet phone can register automatically and get a unique internet phone number. It conforms to the usual habit of ordinary phone users. The internet phone system 100 supports all types of IP, such an a dynamic IP or a static IP.

In the internet phone system 100, a peer to peer communication is established without a Soft Switch, a Proxy, or a GateKeeper. The internet system 100 provides the function of editing graphic greeting words in the form of multimedia. The graphic greeting words replace the traditional method of displaying the phone number of the caller on the display module of an internet phone.

A web site can be established in a server (such as the first area server 102 or the second area server 104) for users to search the authorized information of registered internet phones. The internet phone system broadcasts a broadcasting signal to check the on line statuses of other internet phones.

Although the present invention has been described in considerable detail with reference to certain preferred embodiments thereof, other embodiments are possible. Therefore, their spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An internet phone system for peer to peer communications among a plurality of internet phones, each internet phone having an internet phone number, each internet phone number comprising an area number and an individual number, the internet phone system comprising:
a first area server connected to at least one first internet phone and at least one second internet phone, the first area server having a first area data base, the first area data base recording the internet phone number of the first internet phone and the second internet phone and the corresponding IP addresses of the first internet phone and the second internet phone;
a first area DNS connected to the first area server, the first area DNS used to look up the individual number and the corresponding IP addresses of the first internet phone and the second internet phone, wherein when the first internet phone calls the individual number of the second internet phone, the first area server looks up the IP address of the second internet phone, according to the individual number of the second internet phone, through a DNS system or the first area DNS, to establish a peer to peer communication between the first internet phone and the second internet phone;
a second area server connected to at least one third internet phone, the second area server having a second area data base, the second area data base recording the internet phone number of the third internet phone and the corresponding IP address of the third internet phone;
a second area DNS connected to the second area server, the second area DNS used to look up the individual number and the corresponding IP address of the third internet phone; and
an upper layer server connected to the first area server and the second area server, wherein when the first internet phone calls the internet phone number of the third internet phone, the upper layer server looks up the IP address of the third internet phone, according to the individual number of the third internet phone, through the DNS system or the second area DNS, to establish a peer to peer communication between the first internet phone and the third internet phone.

2. The internet phone system of claim 1, wherein the first area server obtains the IP addresses of the first internet phone and the second internet phone through the connection action of the first internet phone and the second internet phone, and updates the first area data base and the content of the first area DNS.

3. The internet phone system of claim 1, wherein the second area server obtains the IP address of the third internet phone, through the connection action of the third internet phone, and updates the second area data base and the content of the second area DNS.

4. The internet phone system of claim 1, further comprising a plurality of extra area servers and a plurality of extra internet phones, the upper layer server connected to the extra area servers, the extra area servers connected to the extra internet phones, wherein the upper layer server, the extra area servers and the extra internet phones form a tree structure.

5. The internet phone system of claim 4, wherein when an internet phone does not call the area number, a predetermined area number is determined by a corresponding area server and the peer to peer communication path is via the DNS system, not via the area servers nor via the upper layer server.

6. The internet phone system of claim 1, wherein each of the first internet phone, the second internet phone, and the third internet phone has a display module, and when the peer to peer communication is established, the display module displays the information sent from the caller.

7. The internet phone system of claim 6, wherein the first area server provides a broadcasting signal and the broadcasting signal is displayed on the display modules of the first internet phone and the second internet phone.

8. The internet phone system of claim 7, wherein the first area server periodically broadcasts the broadcasting signal, the broadcasting signal is displayed on the display modules of the first internet phone and the second internet phone, and the first area server checks the on line statuses of the first internet phone and the second internet phone through the broadcasting signal.

9. The internet phone system of claim 6, wherein the second area server provides a broadcasting signal and the broadcasting signal is displayed on the display modules of the third internet phone.

10. The internet phone system of claim 9, wherein the second area server periodically broadcasts the broadcasting signal, the broadcasting signal is displayed on the display modules of the third internet phone, and the second area server checks the on line status of the third internet phone through the broadcasting signal.

11. The internet phone system of claim 6, wherein the information sent from the caller is a graphic greeting word.

12. The internet phone system of claim 1, wherein the first area server provides relating information of internet phone users according to the limits of authority.

13. The internet phone system of claim 12, wherein the relating information of internet phone users comprises the name of the users, the internet phone numbers, and the on-line statuses.

14. An internet phone system for peer to peer communications among a plurality of internet phones, each internet phone having an individual number, the internet phone system comprising:
a first DNS;
a first area server connected to the first DNS, a first internet phone, a second internet phone, and a third internet phone, the first area server having a first area data base, the first area data base recording the internet phone numbers of the internet phones and the corresponding IP addresses of the internet phones, the first area server obtaining the IP addresses of the internet phones through the connection action of the internet phones and updating the internet phone numbers and the corresponding IP addresses in the first DNS, wherein when the first internet phone calls the individual number of the second internet phone, the first internet phone looks up the IP address of the second internet phone, through a DNS system or the first area DNS, to establish a peer to peer communication between the first internet phone and the second internet phone.

15. The internet phone system of claim 14, wherein each internet phone further comprises an area number and the area number and the individual number of each internet phone constitute a internet phone number, the internet phone system further comprises:
a second area server connected to at least one forth internet phone, the second area server having a second area data base, the second area data base recording the internet phone number of the forth internet phone and the corresponding IP address of the forth internet phone;
a second area DNS connected to the second area server, the second area DNS used to look up the individual number and the corresponding IP address of the forth internet phone; and
an upper layer server connected to the first area server and the second area server, wherein when the first internet phone calls the internet phone number of the forth internet phone, the upper layer server looks up the IP address of the forth internet phone through the DNS system or the second area DNS to establish a peer to peer communication between the first internet phone and the forth internet phone.

16. The internet phone system of claim 15, wherein the second area server obtains the IP address of the forth internet phone through the connection action of the forth internet phone and updates the second area data base and the content of the second area DNS.

17. The internet phone system of claim 15, further comprising a plurality of extra area servers and a plurality of extra internet phones, the upper layer server connected to the extra area servers, the extra area servers connected to the extra internet phones, wherein the upper layer server, the extra area servers and the extra internet phones form a tree structure.

18. The internet phone system of claim 17, wherein when an internet phone does not call the area number, a predetermined area number is determined by a corresponding area server and the peer to peer communication path is via the DNS system, not via the area servers nor via the upper layer server.

19. The internet phone system of claim 15, wherein each of the first internet phone, the second internet phone, the third internet phone, and the forth internet phone has a display module, and when the peer to peer communication is established, the display module displays the information sent from the caller.

20. The internet phone system of claim 19, wherein the first area server provides a broadcasting signal and the broadcasting signal is displayed on the display modules of the first internet phone, the second internet phone, and the third internet phone.

21. The internet phone system of claim 20, wherein the first area server periodically broadcasts the broadcasting signal, the broadcasting signal is displayed on the display modules of the first internet phone, the second internet phone, and the third internet phone, and the first area server checks the on line statuses of the first internet phone, the second internet phone, and the third internet phone through the broadcasting signal.

22. The internet phone system of claim 19, wherein the second area server provides a broadcasting signal and the broadcasting signal is displayed on the display modules of the forth internet phone.

23. The internet phone system of claim 19, wherein the information sent from the caller is a graphic greeting word.

24. The internet phone system of claim 14, wherein the first area server provides relating information of internet phone users according to the limits of authority.

25. The internet phone system of claim 24, wherein the relating information of internet phone users comprises the name of the users, the internet phone numbers, and the on-line statuses.

26. A method for establishing a peer to peer communication in a internet phone system, the method comprising:
sending the IP address of the second internet phone to a second area server through the connection action of a second internet phone;
recording the IP address of the second internet phone in the data base of the second area server and in a second area DNS;
calling the fixed internet phone number of the second internet phone by a first internet phone, wherein the first internet phone searches the IP address of the second internet phone in a DNS provided by an ISP or in the second area DNS; and
establishing a peer to peer communication, by the first internet phone, according to the IP address of the second internet phone.

27. The method of claim 26, further comprising:
sending the MAC number of the second internet phone, the IP address of the second internet phone, and a predetermined internet phone number to the second area server;
determining the fixed internet phone number of the second internet phone according to the MAC number of the second internet phone and the predetermined internet phone number;
sending the fixed internet phone number of the second internet phone to the second internet phone; and
updating the fixed internet phone number of the second internet phone and the corresponding IP address in a second DNS.

28. The method of claim 26, further comprising:
setting the new fixed internet phone number of the second internet phone on the web site in the second area server;
sending the MAC number, the IP address, and the new fixed internet phone number of the second internet phone to the second area server;
sending back the new fixed internet phone number to the second internet phone and updating the fixed internet phone number and the corresponding IP address in the second area DNS; and
changing the fixed internet phone number of the second internet phone to the new fixed internet phone number.

29. The method of claim 26, further comprising:
broadcasting a broadcasting signal periodically, so that the broadcasting signal is displayed on the display modules of the first internet phone and the second internet phone; and
checking the on line statuses of the first internet phone and the second internet phone through the broadcasting signal.
